(19) United States
(12) Patent Application Publication
(10) Pub. No.: US 2026/0231933 A1
(43) Pub. Date: Aug. 13, 2026

(54) A COMPOUND BASED ON PERACETIC ACID AND ADDITIVES TO COMBAT FREEZING OF PLANTS

(71) Applicant: Sasan Sartipi, Tehran (IR)

(72) Inventor: Sasan Sartipi, Tehran (IR)

(21) Appl. No.: 19/486,924

(22) PCT Filed: May 29, 2023
(86) PCT No.: PCT/IB2023/055488

§ 371 Date: Dec. 30, 2025

(51) Int. Cl. A01N 31/02; A01N 25/30; A01P 1/00; A01P 21/00

(52) U.S. Cl. CPC A01N 31/02; A01N 25/30; A01P 1/00; A01P 21/00

(57) ABSTRACT

The invention of a compound based on peracetic acid and additives to combat freezing of plants and reduce the amount of damage to agricultural products in spring cold by eliminating the causative agent of Pseudomonas syringae and other bacteria and the method of using it is a new method to fight and destroy the bacterium that causes the ice nucleus Pseudomonas syringae. In this invention, the fight against bacteria causing ice nucleation is carried out using peracetic acid solution with water solvent along with an adjuvant to reduce surface tension as attack dose. The mechanism of action of peracetic acid is oxidation; The mechanism of oxidation includes electron transfer, peracetic acid breaks the sulfhydryl bonds (H—S) and sulfide bonds (S—S) in proteins and enzymes and destroys the cell wall, thereby oxidizing the outer membrane of bacterial cells and carries out the act of disinfection.

### TECHNICAL FIELD OF THE INVENTION

The present invention is related to compounds and also to the method of using these compounds to prevent damage to plants due to spring frost and to prevent damage to agricultural products by using these compounds and it is also related to a method to destroy the bacteria causing the ice nucleus Pseudomonas syringae to prevent frostbite of plants and also related to biodegradable compounds without residual substances in plants or fruits and agricultural products.

### PRIOR ARTS

Frostbite is one of the most important factors threatening agricultural products (agricultural, horticultural and greenhouse). The problem of freezing causes millions of dollars of damage to agricultural products produced in the world every year. In the past, it was believed that with the decrease in temperature at the beginning of the growing and flowering season of plants, due to the freezing of the moisture on the plants as well as the water in the twigs and leaves of the plants, the formation of ice crystals under the leaves and also the twigs is natural and the resulting freezing is inevitable. As the earth gets warmer due to the increase of greenhouse gases, the awakening of plants and the start of germination is closer to the cold season every year. The changes in the temperature of the earth originate from its position in the orbit around the sun. The location of the earth in each part of the orbit around the sun creates special weather conditions. The creation of cold air masses generally occurs in the winter seasons, but in many cases during the change of season and for some time after the change of season, the creation of these unbalanced systems is a natural and unavoidable thing. Thus, with the early germination of plants and premature flowering, the interference of the germination time with severe weather changes is always increased, and due to early germination, the plants are more at risk of frost than in previous years.

Cold and freezing always cause significant damages to the economy and production cycle of agricultural products over the years, so that the mentioned factors are considered as one of the most important damage factors in agricultural products. On average, the production efficiency of crops in the years when plants suffer from frost due to premature flowering is very low, and in some areas, the reduction is more than 50% of the actual production capacity.

Crystallization of ice crystals at temperatures close to zero degrees generally occurs around an external factor. The presence of dust particles and some organic materials on the leaves increases the speed of ice crystal formation. In most cases, due to the presence of salts in the moisture in plants, the freezing of the vessels requires a very low temperature and a long period of exposure to sub-zero temperatures, but the surface of the leaves, especially the lower part of the leaves, can immediately freeze when the temperature reaches to zero degrees to suffer local freezing and destruction of leaf tissue. The destruction of leaves and in many cases the destruction of buds causes the plant's ability to produce a product to decrease. In these cases, the use of factors that reduce the effects of temperature stress, such as seaweed or some chemicals, is recommended, but in most cases, only further destruction is prevented and the required reconstruction process is very slow. In the recent discoveries of scientists in the field of microbiology, it was found that the microorganisms found in nature, especially the bacteria found on the leaves and trunks of plants, can themselves create a suitable nucleus for creating ice, and their secreted substances, including the proteins secreted by the bacteria can become a suitable nucleus to create the initial ice crystal. Today, bacteria that produce ice nucleus are one of the factors that aggravate colds. The Pseudomonas with its Greek origin meaning deceptive unit, is an important group of Gram-negative bacteria belonging to the Proteobacteria branch, Gammaproteobacteria class. These aerobic organisms are very diverse. Species of this category of bacteria are often rod-shaped, without spores, flagellated, catalase positive, oxidase positive and motile. The metabolism of Pseudomonas species is respiratory and they do not have a fermentation state. These bacteria are widely found in soil, water, plants, and animals, and some of them that are soil-based are able to use 150 organic compounds in plants as a source of carbon and energy. Pseudomonas syringae is a dangerous plant pathogen and the cause of many plant diseases, and it uses all kinds of plants as hosts to continue its life cycle on these plants, but other Pseudomonas are less pathogenic than Pseudomonas aeruginosa. Pseudomonas are classified based on rRNA/DNA structure and common culture characteristics.

A group of bacteria turns water into ice. This process is carried out by proteins present on the surface of bacteria, which are known as ice nucleation factors or ice nucleation-active protein (INA protein, Ice nucleation-active protein). These bacteria exist on the surface of plants. These bacteria, with their activity and increase in population, contribute to the occurrence of frostbite in plants at higher temperatures than usual, in other words, it causes water to freeze at temperatures hotter than usual. Pseudomonas syringae, Pseudomonas fluorescens, Pantoea agglomerans, Xanthomonas spp and Pseudomonas putida bacteria have been identified as ice nucleating bacteria. The most common cause of plant frostbite is the surface proteins of bacteria that exist on the surface of plants, especially Pseudomonas syringae, which is the most active in producing ice nuclei among the related species and acts as the center of ice nucleus formation. The formation of ice crystals damages the plant tissues and interrupts the process of transporting water and nutrients by xylem and phloem. If these bacteria are not present or the surface proteins of bacteria are not present in many cases, ice does not form and plants are not damaged.

One of the best examples for preventing frostbite caused by bacteria and preventing the creation of ice nuclei is the use of the ice minus bacteria method in Pseudomonas syringae bacteria. The mass of the colony volume of this bacterium is found in large quantities on the surface of the leaves of many crops and fruit trees and greenhouse products. Apparently, many strains of this bacterium produce ice-making proteins on the surface of their cells, and the presence of these proteins causes the formation of ice at a temperature slightly above zero degrees Celsius which this protein causes the crops and other agricultural products to freeze and makes it easy for bacteria to invade plant tissues. Ice nucleation producing proteins are coded by the inaZ gene. In many bacteria (such as Escherichia coli), due to the lack of inaZ, they do not have the ability to produce ice nucleating protein. However, if this gene is destroyed in Pseudomonas syringae, this ability is lost. As a result, by using genetic engineering technology, bacteria without the inaZ gene can be produced without protein production. In an experiment conducted by Steven Linda and his colleagues, they first cloned the gene responsible for ice nucleation in Pseudomonas syringae using a Cosmid vector in Escherichia coli bacteria. Then Escherichia coli cells receiving recombinant DNA were searched for ice nucleus formation at −9° C. A part of this gene was removed by homologous recombination DNA method and the remainder was returned to Pseudomonas syringae chromosome in the same way. In this way, Ice negative (Ice−) strains were obtained. Ice-negative bacteria are species of Pseudomonas syringae that lack the ability to produce the surface protein that is present in wild-type Pseudomonas syringae. Ice-negative strains are similar to their parent strain, Ice-positive, in all their other properties, except for the ability to form ice nuclei. When the mutant strains (Ice−) are sprayed on the surface of strawberry leaves, these bacteria are settled on the surface of the plant leaves, which can successfully compete with the bacteria of the sensory types (Ice+). With this method, the created colony of bacteria mostly includes the group of ice-negative bacteria, thus protecting plants from freezing damage. Despite the many advances in the field of genetic engineering and the production of a species of bacteria that lacks the protein that produces the frozen core, however, the preparation of this type of bacteria to deal with frostbite brings a lot of cost, besides, considering Due to the climatic conditions of each region and extreme temperature changes, this method is not completely effective in dealing with frostbite. Also, in many countries, it is illegal to use genetic manipulation in agriculture to produce bacteria and other transgenic agricultural products.

In an Chinese invention with publication number CN114868745A which is filed dated 27 Apr. 2022 titled “Method for improving anti-freezing effect of apricot flowers” iscloses a method for improving the anti-freezing effect of apricot flowers, which adopts CaCl2 The composite antifreezing agent CM specially made by Salicylic Acid (SA) and Ethylene Glycol (EG) is sprayed on the apricot flowers in the full bloom stage of the golden sun apricot under the condition of semilethal low temperature, so that the relative conductivity and H of the apricot flowers after low-temperature freezing injury can be effectively reduced 2O2 MDA content; the content of soluble sugar, soluble protein and proline in the osmotic adjusting substances is improved; enhancing activities of SOD, POD, CAT and APX of antioxidant enzyme system. In addition, after CM treatment, under semilethal low-temperature stress, the browning rate of apricot flowers is far lower than CK and lower than that of single exogenous drug And treating with an agent. The browning rate of apricot flowers is observed to be lower than that of a control at 0 h and is lower than that of CK 36.2% after 24 h recovery.

In an Korean invention with publication number KR20130046912A which is filed dated 28 Oct. 2011 titled “An agent for preventing cold damage of flowers of fruit trees and garden fruits” provided a frost damage prevention agent for flowers of fruit trees and fruit vegetables is provided to prevent a bud from being frozen by inducing generation of a cold tolerant material. The frost damage prevention agent for flowers of fruit trees and fruit vegetables contains 0.1-25 wt % of glycine betaine, 1-20 wt % of saccharides, 0.1-20 wt % of rare earth resources, 0.5-15 wt % of honey or sugar, and water or one or more water soluble diluents selected among lactose, sodium bicarbonate, and sodium sulfate. The agent additionally contains 5-20 wt % of potassium phosphate monobasic, 0.1-15% of proline, 1-20 wt % of calcium nitrate, 0.05-10 wt % of boric acid, and 0.05-10 wt % of zinc nitrate.

In another Chinese invention with publication number CN1528147A which is filed dated 29 Sep. 2003 titled “Salicylic acid cold resistance agent and method for cold resistance” discloses a salicyclic acid cold-resisting agent, its composition comprises salicylic acid 0.3-0.9 mmol/L, rapin 0-1 ppm, calcium chloride 0-15 ppm and the solvent is water. Said invention is used for raise the cold resistance of tropical crops and fruit trees, including banana tree, leechee and mango, etc. Said invention also provides its application method. This invention also contains the sugar or the molasses waste liquid that account for cold-resistance agent 3-8% weight and it being preceding 12-72 hour that arrives at cold wave, and the blade with salicylic acid cold-resistance agent spray solution plant makes solution under spontaneous current on the blade.

In another Chinese invention with patent number CN108002924A which is granted dated 19 Nov. 2021 titled “A kind of cold-resistant microbial liquid fertilizer and preparation method thereof” provides a kind of cold-resistant microbial liquid fertilizer, the cold-resistant microbial liquid fertilizer includes alginic acid, low temperature resistant microbial inoculum, a great number of elements fertilizer and organic liquid waste, count in parts by weight, 0.5 1.5 parts of alginic acid, 12 parts of low temperature resistant microbial inoculum, a great number of elements fertile 12 25 parts, 30 40 parts of organic liquid waste. The liquid fertilizer provided in this invention includes 5-10 parts of potassium humate and 1.4-3.4 parts micro. In such a way that the trace element includes zinc 0.4-0.6 part, 0.2-0.5 parts of copper, 0.5-0.8 parts of iron, 0.2-0.5 parts of manganese, 0.1-0.5 parts of molybdenum. Also it further includes 0.1-0.5 parts of chelating agent, the chelating agent are sodium ethylene diamine tetracetate.

Also in another Chinese invention with publication number CN109574754A which is filed dated 29 Dec. 2018 titled “Cold-resistant Water soluble fertilizer and preparation method thereof” discloses cold-resistant Water soluble fertilizers and preparation method thereof. Wherein, cold-resistant Water soluble fertilizer includes a great number of elements Water soluble fertilizer and low-temperature resistance exogenous compositions, the low-temperature resistance exogenous compositions include salicylic acid, glycine betaine, S-abscisic acid and degeneration-resistant growth-promoting agent, the degeneration-resistant growth-promoting agent is sodium selenite and/or mannitol, and the content of the low-temperature resistance exogenous compositions is 0.1~5.2wt % of a great number of elements Water soluble fertilizer. The cold-resistant Water soluble fertilizer can punching apply or in conjunction with foliage-spray by way of use.

In an Czech invention with publication number CZ304517B6 which is filed dated 27 Feb. 2013 titled “Formulation for protection plants from frost and plant protection method” provides a formulation for protection plants from frost containing at least one acylamidopropyl dimethylbetaine and at least one aminoborate. The frost protection product contains at least one compound of the formula I, Wherein R1 is C8-C20 alkyl or C8-C20 alkenyl, and at least one aminoborate obtainable by reaction of boric acid with an alkanolamine of formula II HO-R2-NR3R4 (II) wherein R2 is a saturated C2-C4 hydrocarbon chain, optionally substituted with a hydroxy or amino group on any carbon atom except for geminal substitution, and R3 and R4 are independently hydrogen or -R2-OH. A composition according to claim 1 wherein R1 is derived from natural lipophilic carboxylic acids present in precursors selected from the group consisting of coconut oil, hydrogenated coconut oil, tallow, hydrogenated tallow, palm oil.

In an European invention with publication number EP2772137A1 which is filed dated 21 Feb. 2014 titled “Composition for protecting plants against frost and method of plant protection” provides a composition for plant protection against frost, characterized in that it contains at least one substance of the general formula (I) wherein R1 is C8-C20 alkyl or C8-C20 alkenyl, and at least one aminoborate obtainable by reaction of boric acid with alkanolamine of the general formula (II) HO-R2-NR3R4. And R2 is a saturated C2-C4 hydrocarbon chain, optionally substituted with hydroxy or amino group at any carbon atom with the exception of geminal substitution, and R3 and R4 are independently hydrogen or -R2-OH.

Also in another Korean invention with patent number KR102070788B1 which is granted dated 29 Jan. 2020 titled “Nutritional Supplements for Preventing Cold Weather Damage and Manufacturing method thereof” relates to an anti-freezing plant nutritional agent and to a manufacturing method thereof. The anti-freezing plant nutritional agent comprises: 30 to 40 wt % of a Dulse extract; 10 to 20 wt % of a gulfweed extract; 5 to 15 wt % of shell powder; 10 to 20 wt % of trehalose; 10 to 30 wt % of betaine; and 1 to 10 wt % of a microbial agent, thereby having an anti-freezing effect, promoting growth and development, increasing the sugar content of the fruits, the hardness of the fruits and the storage quality of the fruits, and preventing soil acidification. The Dulce extract is added to 100 parts by weight of Dulce 300 to 400 parts by weight of seawater and heated for 10 to 12 hours at 110~120° C., the mother and child extract is added 100 to 200 parts by weight of seawater to 100 parts by weight of mother and child, and heated at 100 to 110° C. for 5 to 6 hours.

In another Korean invention with patent number KR20160118554A which is granted dated 30 Mar. 2017 titled “Composition for preventing cold-weather damage and manufacturing the same” relates to a composition for preventing fruiting of trees and a method for preparing the same and more particularly to a microcrystalline wax, a paraffin wax mixed with a growth regulator, a surfactant, a pigment and water, Mixing the mixed paraffin wax and heating and melting the mixture at a temperature of 90 to 130° C., adding the surfactant to the molten raw material through the raw material melting step, and performing the reaction at a temperature of 100 to 110° C. for 2 to 4 hours Adding a dye to the mixture emulsified through the emulsification step and stirring the mixture at a temperature of 80 to 90° C., adding hot water to the mixture containing the dye through the dye input step, heating the mixture at 90 to 100° C. For 30 to 90 minutes, and a step of adding the hot water-added mixture It comprises a cooling step of cooling.

And in a WIPO invention with publication number WO2001052653A1 which filed dated 25 Dec. 2000 titled “Compositions for protecting plants and method of using the same” provides a compositions for protecting plants containing at least one member selected from among trehalose, which occurs widely in plants, microorganisms, insects, fungi, etc. and seemingly participates in the drought resistance and cold resistance of plants largely, its derivative trehalose-6-phosphate, and a non-reducing trisaccharide selaginose showing behaviors and physical properties closely similar to trehalose in the environment, and water-soluble calcium which prevents tissue softening and necrosis of plants. When applied to plants, these compositions remarkably improve the drought resistance and cold resistance of plants. The application of the above composition at a dilution ratio in water up to 10,000 times by volume to the stems, leaves and/or fruits of plants makes it possible to remarkably improve the drought resistance and cold resistance of plants and improve the yield and commercial value of the crops particularly by elevating the calcium content in the crops.

### OBJECT OF THE INVENTION

The aim of the present invention is to reduce the amount of damage to plants in the veins, vessels and especially the living tissue of plants. Because the mentioned bacteria have developed a way to more easily access the food resources of the plant during the process of evolution, which includes the secretion of proteins and effective enzymes to create an ice nucleus, thereby destroying living tissues. thus, the general objectives of the methods and products used during the creation of the ice nucleus can be focused on three issues. The first category is based on the elimination of the bacterial agent as the main cause of ice nucleus formation, the second topic is the treatment and healing of the damage caused to the plant after the occurrence of freezing, The third category focuses on preventing the secretion of proteins by the mentioned bacteria and reducing the possibility of creating ice nuclei during the temperature drop, therefore, the present invention, by focusing on eliminating the bacterial agent and targeting the rapid reduction of the bacterial colony on the plant components, minimizes the amount of ice nucleation during the temperature drop.

### DESCRIPTION OF THE INVENTION

The present invention is a type of chemical compound based on biocompatible materials with the morphology of plants, which does not create toxic or harmful residues for nature due to its biodegradability. Ice nucleating bacteria generally have a hydrophobic coating. The presence of impermeable layers in the outer shell of bacteria has made them to show great resistance both to extreme temperature changes and to common agricultural Pesticides. In this invention, with the strategy of reducing the hydrophobicity of the bacterial outer membrane, the use of several nonionic surfactants at the same time as an adjuvant causes a wide range of compounds containing fat molecules as well as protein structures on the bacteria to be dissolved in the said compound, and the conditions for The performance of the main oxidizing agent should be provided. In this invention, by using the reaction of hydrogen peroxide in the vicinity of acetic acid, next to the catalyst of sulfuric acid, in the environment of the 316 grade L steel homogenous reactor, it is possible to produce Ethan per oxyacid. Compounds based on Ethan per oxyacid (Peracetic acid0 with the chemical formula CH3CO3H is a chemical compound with Pubchem ID 6585, whose molar mass is 76.05 g/mol. The appearance of this compound is a colorless liquid. Among other characteristics of this compound, the density is 1.266 g/cm at 15 degrees Celsius, the vapor pressure is 14.5 mm/Hg, the melting point is −0.2 degrees Celsius and the boiling point is 110 degrees Celsius, the reaction continues until reaching a purity of minimum 20% by simultaneously adding raw material. After completing the initial reaction, betaine surfactant with the formula of trimethylammonio acetate and the chemical formula of C5H11NO2 with a volume ratio of 25% in aqueous medium is added to the reaction container to mix with the solution created from the previous compounds and become homogeneous. The weak intermolecular force in peracetic acid and its great tendency to decompose make it possible for it to be constantly considered as a source of strong oxidant production. The tendency of the surface molecules to escape from the pull force in the liquid and their decomposition causes the molecules of peracetic acid in the aqueous medium to constantly decompose and turn into carbonic gas and water. In the meantime, the discharge of electrons of oxygen ion during the oxidation process accelerates the decomposition process of the liquid containing peracetic acid. The introduction of betaine nonionic surfactant and the homogenization of the molecular distribution of the surfactant among the peracetic acid molecules makes the arrangement of the molecules to reach a regular structure and in a spatial network of the surfactant molecules between the peracetic acid molecules and the water of the reactor, increase the amount of intermolecular tension in the created compound. In this way, the rate of decomposition of the oxidizing agent (peracetic acid) during the storage of the solution in bulk is increased and the risks caused by the decomposition of the said solution are minimized. On the other hand, in the second reactor, using soybean oil and coconut oil in equal proportions, with a partial increase in temperature, a combination of fatty acids in coconut oil and fatty acids in soybean oil is created. By adding soda to the mentioned compound in the stirred reactor environment, glycerin and biodegradable nonionic surfactant composition based on common soyamide and cocamide surfactants are created. Due to having a wide group of fatty acids, the present composition can dissolve most of the hydrophobic compounds and dissolve wax derivatives, saturated fats or proteins on the body of the bacteria that make it hydrophobic. On the other hand, the presence of fats, wax and natural substances on the leaf and also on the back of the leaf gives the vital elements of the plant a hydrophobic effect. In these conditions, water-based materials are generally not evenly distributed on the plant elements and become liquid particles and drops of water-based materials. With the addition of nonionic surfactant, the surface tension of the leaf changes and water-based materials become a uniform film is distributed over the entire surface. Now, when using the combined solution of peracetic acid with betaine, the combination of the mentioned surfactants can be added to the main composition in the ratio of 3-5 liter/1000 lit water and immediately after that, using a sprayer on the points of accumulation of bacteria, which is the same back and it is sprayed on thinner leaves and branches. By placing nonionic surfactant compounds on the leaves, the surface tension of the leaves is reduced and the strong oxidizing compound of peracetic acid is placed in the vicinity of the covering of bacteria and plant elements. Considering the resistance of plant cells to weak oxidation processes, primarily the oxidizing compound acts on the proteins of the outer coating of the bacteria and causes the death of the bacteria by destroying the molecules of the membrane constituents for two reasons. First, the cytoplasm in the bacteria seeps out from the membrane area and causes the death of the bacteria, and second, with the loss of the membrane cover in some places, the ion exchange process between the bacteria and the surrounding environment is severely unbalanced, and this causes paralysis and death of bacteria. In this way, when a possible severe drop in temperature is determined, the mentioned method and the aforementioned combination can be used to destroy the mentioned bacterial colony quickly, and before the severe drop in temperature, the main cause of ice nucleus protein formation can be eliminated.

In general, in this method of combating frostbite to eliminate the bacteria that cause ice nucleus, after checking the weather conditions from the weather station, in the first stage, the combination of peracetic acid in the form of foliar spraying on agricultural products infected with bacteria along with adjuvant with cocamide diethanolamine (combination of fatty acids of coconut oil and diethanolamine) and in the second stage, betaine along with soyamide and peracetic acid was used.

Peracetic acid is a potential oxidizing agent consisting of hydrogen peroxide and acetic acid, which is easily dissolved in water and decomposes into non-toxic and safe by-products (water, acetic acid and oxygen), and this product can be introduced as the best oxidizer after ozone. In addition, this composition does not leave any residue in the environment and is completely environmentally friendly. The mechanism of action of peracetic acid is oxidation, which involves electron transfer, peracetic acid breaks sulfhydryl bonds (H—S) and sulfide bonds (S—S) in proteins and enzymes, in fact, this substance oxidizes the outer membrane of bacterial cells, endospores, yeasts, and mold spores, as well as the chitinous wall of pests and destroys them.

Compounds based on ethane peroxyacid (peracetic acid) in destroying a wide range of fungi including Pythium, Fusarium, Aspergillus, Phytophtora and a range of bacteria such as Pseudomonas syringae, Bacillus sp, Mycobacterium sp, Clostridium sp, Escherichia coli, Staphylococcus aureus, Xanthomonas axonopodis pv. Citri the application of peracetic acid powder and solution is considered as a disinfectant. Pseudomonas syringae, the bacterium that causes ice nucleus in spring cold, is an important bacterial agent for creating frost foci in fruit trees. According to the mechanism of action of peracetic acid, the mechanism is such that as a high-level disinfectant oxidizes the external cell membrane of microorganisms. The oxidation mechanism involves electron transfer. When a stronger oxidant is used, electrons are transferred to the microorganism much faster, causing the microorganism to be rapidly inactivated.

### DESCRIPTION OF AN IMPLEMENTATION METHOD

[symbol] present invention, for the first time, powdered and specifically Liquid compounds containing a peracetic acid disinfectant with a dose of 3-5 Liter/Kg per thousand liters of water, Phytowet adjuvant (as a surface tension reducer) with a dose of 0.5 to 1 Liter per thousand liters of water and in second time, cocamide diethanolamine (combination of fatty acids of coconut oil and diethanolamine), betaine along with soyamide and peracetic acid were used. After receiving the information from the meteorological station of each state, the solution was prepared and used in the form of foliar application on agricultural products (plant leaves and twigs). It should be noted that foliar spraying 12 hours before the arrival of the cold air front and with inquiries from the statehood weather stations, peracetic acid with phytovet adjuvant as an attack dose and after 12 hours a solution containing cocamide diethanol, betaine and soyamide surfactant along with peracetic acid were used to completely eliminate bacterial contamination. Decomposition of peracetic acid with water solvent leads to the production of hydrogen peroxide and acetic acid, which by producing billions of free radicals, causes the destruction of all kinds of fungi, viruses, bacteria and pests. In fact, peracetic acid is a potential oxidizing agent consisting of hydrogen peroxide and acetic acid, which is easily dissolved in water and decomposes into non-toxic and safe by-products, water, acetic acid and oxygen, and this product can be introduced as the best oxidizer after ozone. In addition, these compounds do not leave any residue in the environment and are completely environmentally friendly. The mechanism of action of peracetic acid is oxidation; The mechanism of oxidation includes electron transfer, peracetic acid breaks sulfhydryl bonds (H—S) and sulfide bonds (S—S) in proteins and enzymes and destroys cell walls and in this way, it oxidizes the outer membrane of bacterial cells, endospores, yeasts and mold spores, and therefore, performs the disinfection action. The use of these compounds with the right dose does not have any negative effect on the plant tissue, such as leaf burning and leaf fall, etc. It should be noted that, in order to have a potential effect and increase the performance of peracetic acid (with the right dose) and the longevity of this disinfectant compound on the leaf surface and the effect of surface tension reducing compound, an adjuvant called phytowet, along with cocamide and betaine are used. It should be noted that in order to have potential effect and increase the performance of peracetic acid (w

### BRIEF DESCRIPTION OF FIGURES

FIG. 1 in which the appropriate and optimal dosage table provided for the use of peracetic acid and related compounds to fight and destroy the bacteria that cause ice nuclei, especially Pseudomonas syringae.

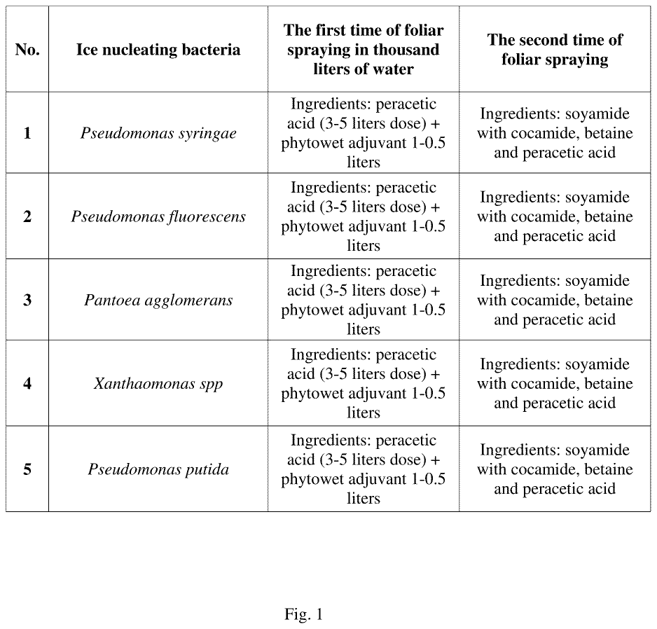

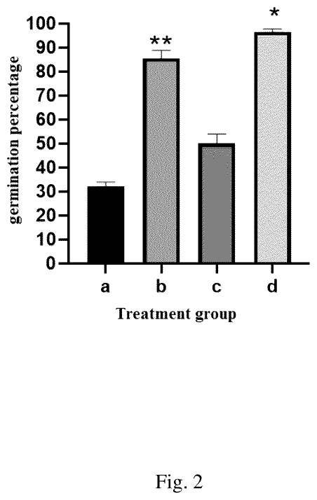

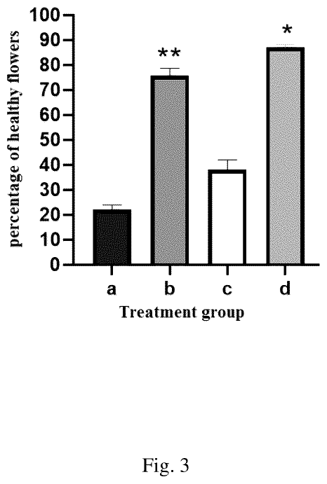

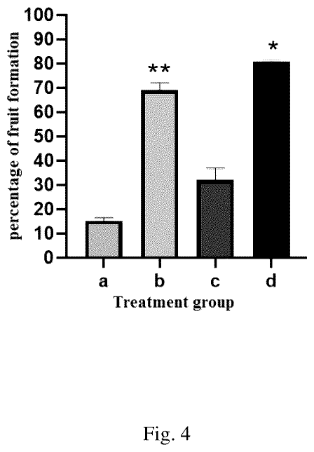

FIG. 2 shows the comparison chart of average germination percentage in treatment groups of a, b, c, d which includes:
a) Control Group
b) Adjuant+peracetic acid
c) Soyamide+Betaine+Cocamide
d) Adjuant+peracetic acid and Soyamide+Betaine+Cocamide

FIG. 3 shows the comparison chart of average percentage of healthy flowers in treatment groups of a, b, c, d which includes:
a) Control Group
b) Adjuant+peracetic acid
c) Soyamide+Betaine+Cocamide
d) Adjuant+peracetic acid and Soyamide+Betaine+Cocamide

FIG. 4 shows the comparison graph of average percentage of fruit formation in treatment groups of a, b, c, d which includes:
a) Control Group
b) Adjuant+peracetic acid
c) Soyamide+Betaine+Cocamide
d) Adjuant+peracetic acid and Soyamide+Betaine+Cocamide

### AN EXPLICIT AND PRECISE STATEMENT OF THE ADVANTAGES OF THE CLAIMED INVENTION OVER PREVIOUS INVENTIONS

Non-resistance of bacterial strains to peracetic acid and other compounds in the tank due to the rapid effect
The property of fungicide and destroying other viruses and pathogenic agents
Cost-effectiveness compared to genetic engineering
Improvement in the quality and quantity of the final product
Peracetic acid is widely produced with different concentrations inside the country and by creating a market for peracetic acid to fight against all kinds of pathogens (fungi, bacteria and viruses) and also to fight against plant pests, it naturally creates employment, more production, no need to import all kinds of chemical poisons, will reduce the costs and prevent foreign exchange from going out.
It does not have a negative effect on the plant tissue, such as leaf burning and leaf fall, etc.
A very practical and easy method for farmers.

What is claimed is:

1. The invention of a compound based on peracetic acid (powder and liquid form) and additives to combat freezing of plants and reduce the amount of damage to agricultural products in spring cold by eliminating the causative agent of Pseudomonas syringae contains at least one peracetic acid component and at least one nonionic surfactant component from the betaine family and one nonionic surfactant component from the soyamide family and at least one nonionic surfactant component from the cocamide family.

2. The invention of a method of combating the spring freezing of plants by using a disinfecting detergent compound, including at least two times washing of leaves and complete washing of plants with the help of an oxidizing compound with nonionic surfactants and at least one schedule of washing and disinfecting the plant with the help of two types compound close to each other as a disinfectant and detergent in the time before the arrival of spring cold.

3. The compound of claim 1 in which in order to create and produce liquid peracetic acid with nonionic surfactant, an anti-acid steel reactor with temperature control capability is used, in which the nonionic surfactant compound is mixed with peracetic acid until complete homogenization.

4. The compound of claim 1 in which the fixing nonionic surfactant can be betaine with a concentration below 30%, and betaine can also be diluted when added with water.

5. The compound of claim 1 in which the nonionic surfactant molecules are completely homogeneously placed between the peracetic acid molecules and create a molecular network, and with this, it reduces the tendency of the peracetic acid molecule to break down into two molecules of water and carbon dioxide and increases the durability of the compound.

6. The compound of claim 1 in which the use of peracetic acid compound along with betaine, due to the propensity for high oxidation of peracetic acid, in the first stage, decomposes the coating of ice nucleus producing bacteria as well as the proteins present on the surface of the bark.

7. The compound of claim 1 in which after the destruction of bacteria or proteins on their membranes, in the second step, the presence of nonionic surfactants based on natural fatty acids washes the surface and releases the remaining proteins and bacteria.

8. The compound of claim 1 in which the nonionic surfactants in the compound reduce the surface tension of the leaf and the correct measurement of the compound on the plant surfaces.

9. The compound of claim 1 in which decreasing the surface tension of the leaves and different surfaces of the plant causes bacteria and colonies to be separated from the surface of the plant and transferred to the ground.

10. The compound of claim 1 in which collapsing the decomposable compound can also eliminate fungal diseases on the ground and next to the tree.

11. The compound of claim 1 in which reducing the colonies of Pseudomonas syringae bacteria reduces the formation of ice nucleus and thus reduces the amount of damage to plants when the spring cold arrives.

12. The method of claim 2 in which at least two foliar sprayings are done on the leaves and surfaces of the plant before the arrival of spring cold.

13. The method of claim 2 in which due to the adjustment of the amount of pH of the using compound, animal and bacterial cells are damaged earlier than plant cells and with this method, before causing damage to the structure of the plants, the bacteria that produce ice nucleus are destroyed and released.
